(19) United States
(12) Patent Application Publication
(10) Pub. No.: US 2004/0240005 A1
(43) Pub. Date: Dec. 2, 2004

(54) Editing apparatus and method using thumbnail image

(75) Inventor: Yong Joo Kim, Seoul (KR)

Correspondence Address: JONATHAN Y. KANG, ESQ., LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 10/775,835

(22) Filed: Feb. 9, 2004

(30) Foreign Application Priority Data
Feb. 6, 2003 (KR) 7423/2003

(51) Int. Cl. H04N 1/46

(52) U.S. Cl. 358/537; 358/538

(57) ABSTRACT

Disclosed is an editing apparatus using a thumbnail image, including: an image processing means for processing a broadcasting stream and an image signal to permit the processed broadcasting stream and image signal to be displayed; a display means for displaying an image; an image extracting means for extracting the thumbnail image of the recorded broadcasting stream; a storing means for storing the broadcasting stream and the thumbnail image; and a control means for allowing a plurality of thumbnail images displayed on the display means according to a user's control command and thereby allowing the broadcasting stream represented by the thumbnail image to be edited.

### BACKGROUND OF THE INVENITON

1. Field of the Invention

The present invention relates to an editing method using a thumbnail image, and more particularly, to an editing apparatus and method using a thumbnail image, in which an editable unit section is set, a representative picture on the set section is viewed to a user to thereby allow the user to easily perform the editing function while understanding the overall flow.

2. Description of the Related Art

In the present, since PVR (Personal Video Recorder) stores a TV broadcasting signal in a hard disc or other storage media in the format of a digital signal, it can provide an environment that a user can reproduce again and view the broadcasting signal whenever the user desires as well as in real time.

Unlike the conventional analog recorder, the PVR stores TV broadcasting signal in the format of digital signal, it becomes possible to skip an undesired scene during its reproduction. Especially, a PVR provides a program editing function to delete an undesired scene.

The conventional PVR has a simple program editing function that combines recorded programs or divides one program into two sections.

However, only by the aforementioned simple function, it is impossible to store only a desired part and delete unnecessary part.

FIG. 1 illustrates an example of the program editing method under development in the present.

As shown in FIG. 1, this editing method reproduces the program through a progress bar and stores or deletes a desired section while the user confirms the reproduced picture.

This editing method however needs a long editing time and cannot provide a complicated editing function altering the time sequence because the user has to perform a section editing with reproducing the picture.

In particular, it is impossible to provide a complicated editing function such as re-editing of the time sequence or combining of a part of other recorded program with a part of current recorded program through the aforementioned method.

### SUMMARY OF THE INVENTION

Accordingly, the present invention is directed to an editing apparatus and method using a thumbnail image that substantially obviates one or more problems due to limitations and disadvantages of the related art.

An object of the present invention to provide an editing method of a recorded program using a thumbnail image that allows the user to easily perform the editing function while understanding the overall flow of a program intended to edit without reproducing a recorded program.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve this object and other advantages and in accordance with the purpose of the invention, as embodied and broadly described herein, there is provided an editing apparatus using a thumbnail image, comprising: an image processing means for processing a broadcasting stream and an image signal to permit the processed broadcasting stream and image signal to be displayed; a display means for displaying an image; an image extracting means for extracting the thumbnail image of the recorded broadcasting stream; a storing means for storing the broadcasting stream and the thumbnail image; and a control means for allowing a plurality of thumbnail images displayed on the display means according to a user's control command and thereby allowing the broadcasting stream represented by the thumbnail image to be edited.

Also, the thumbnail image is extracted at a predetermined time interval or at each scene change point.

In addition, the thumbnail image is extracted by using histogram information on each frame of the broadcasting stream.

Further, the editing of the broadcasting stream is performed by deleting, storing and moving the thumbnail image.

In another aspect of the present invention, there is provided an editing method using a thumbnail image, comprising the steps of: extracting and storing the thumbnail image of a broadcasting stream; displaying a plurality of thumbnail images in response to a user's request; editing the plurality of thumbnail images; and editing a section of the broadcasting stream represented by the plurality of thumbnail images.

Also, the extracting step of the thumbnail image is performed while the broadcasting stream is stored.

In addition, the thumbnail image is extracted at a predetermined interval while the broadcasting stream is stored.

Further, the thumbnail image is extracted by using histogram information on each frame of the broadcasting stream.

Furthermore, the thumbnail image is extracted at each scene change point.

Moreover, the editing of the thumbnail image is performed by a method deleting, moving and separately storing a part of the plurality of thumbnail images.

Also, the editing of the broadcasting stream is performed concurrently with the editing of the thumbnail image.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 illustrates an example of the program editing method under development in the present;

FIG. 2 illustrates a base unit of a broadcasting stream (MPEG2);

FIG. 3 illustrates an editing apparatus of a recorded program using a thumbnail image according to the present invention;

FIG. 4 illustrates a thumbnail image extracted in advance while a program corresponding to one hour is recorded;

FIG. 5 illustrates a thumbnail image that a desired recording section is stored and an undesired section is deleted;

FIG. 6 illustrates to move a specific recording section to other section; and

FIG. 7 illustrates that a specific record section has been moved to other section.

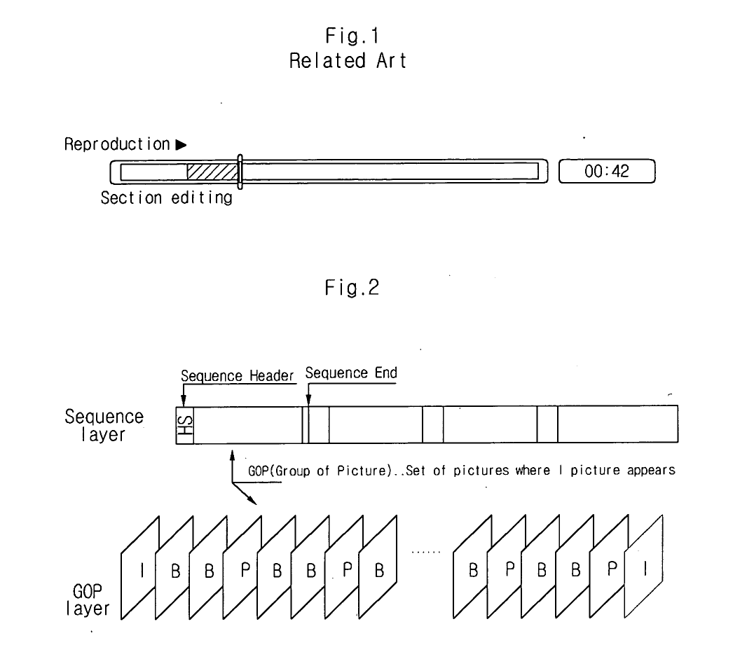

### DETAILED DESCRIPTION OF THE INVENTION

Reference will now be made in detail to the preferred embodiments of the present invention, examples of which are illustrated in the accompanying drawings.

FIG. 2 illustrates a base unit of a broadcasting stream (MPEG2).

Referring to FIG. 2, the base unit of the broadcasting stream is the frame. The broadcasting stream is configured to be capable of being independently reproduced in the unit of GOP (Group of picture) where several frames (I/P/B Picture) are combined. Accordingly, the minimum unit of the section editing should be the GOP unit.

Generally, the unit of GOP is a time of approximately 0.5 second. For example, when the editing section is set in the unit of 60 seconds, about 120 GOPs exist in one editing section.

The present invention extracts and stores a thumbnail image according to a prescribed standard while a program is recorded. When a user intends to edit the recorded program, the inventive method and apparatus make it possible to edit the recorded program with ease.

The standard for extracting the thumbnail image can be set in the unit of a constant time. By using histogram information on each frame, it is possible to detect scene change and to extract the thumbnail image at each scene change point.

The user is allowed to set the time unit for extracting the thumbnail image. Preferably, the time unit is set in the unit of approximately 60 seconds upon considering the preciseness of the editing and the understanding of an overall program flow.

Also, since it is forecasted that the editing unit intended by the user is larger in the scene change unit having a program meaning than in the physical time unit, by extracting the thumbnail image in the unit of scene change, it is possible to provide more convenient editing method.

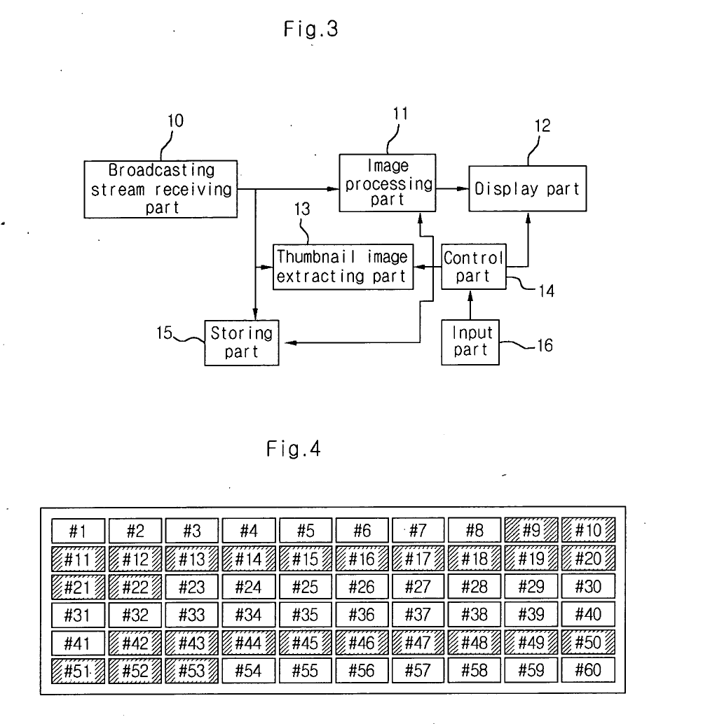

FIG. 3 illustrates an editing apparatus of a recorded program using a thumbnail image according to the present invention.

Referring to FIG. 3, audio/video stream is received through a broadcasting stream receiving part 10 and is image-processed at an image processing part 11. A display part 12 displays the image-processed broadcasting signal.

The program selected by the user is recorded in a storing part 15. At this time, a thumbnail image extracting part 13 extracts the thumbnail image of the recorded program.

The extraction of the thumbnail image is performed at a predetermined time interval or at each scene change point. The extracted thumbnail image is again stored in the storing part 15.

When intending to edit the recorded program, the user inputs a predetermined control command so that it is possible to edit a predetermined recorded section having the thumbnail image as the representative picture.

A control part 14 displays the stored thumbnail image so that the user can view the stored thumbnail image through the display part 12. The user can edit the broadcasting stream of a section represented by the thumbnail image by deleting, storing and moving the thumbnail image.

FIG. 4 illustrates a thumbnail image extracted in advance while a program corresponding to one hour is recorded.

In case of extracting the thumbnail image in the unit of 60 seconds, about 60 thumbnail images are extracted from a recorded program corresponding to one hour.

If it is assumed that PVR can extract the thumbnail image in a size of 100 W×100 H pixels, in case of HD 720P picture (1280 W×720 H), about 60 thumbnail images can be seen on one picture as shown in FIG. 4.

The respective thumbnail images shown on the picture mean a representative picture with respect to a recorded section corresponding to about 60 seconds till a previous frame of a next thumbnail image.

In other words, it can be said that the thumbnail image is a representative image of until a frame right before a next thumbnail image picture is shown after a frame picture of a corresponding thumbnail image is first reproduced.

Thus, since the user can view the thumbnail image representing the respective recording sections through one picture, it is possible to edit the recorded sections with understanding the flow of an overall program.

Describing the editing method, if one of the respective thumbnail images #1, #2, #3, . . . , #59 and #60 shown in FIG. 4 is deleted, the recording section corresponding to 60 seconds represented by the corresponding thumbnail image is automatically deleted.

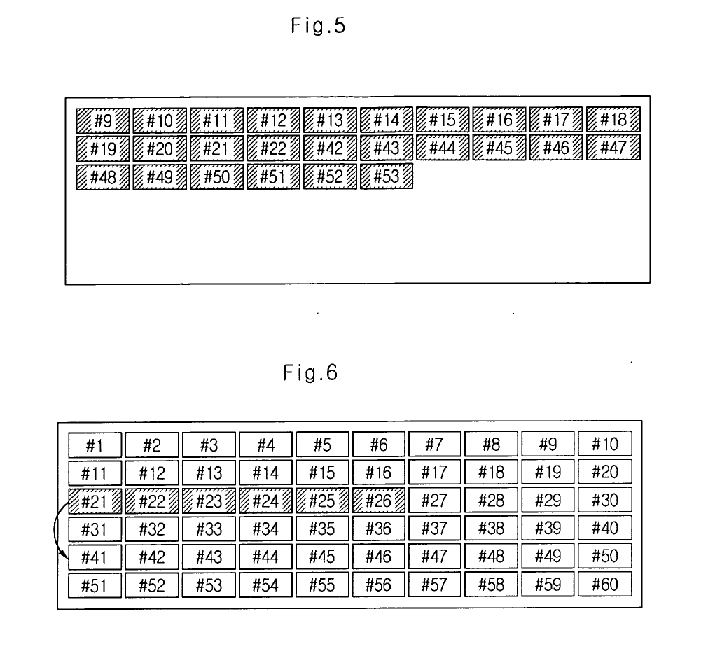

Accordingly, if a desired recording section is stored and an undesired recording section is deleted, a section-edited program can be obtained as shown in FIG. 5.

Also, altering the reproducing sequence of the recorded sections as well as storing and deleting the recorded section can be implemented through the same concept.

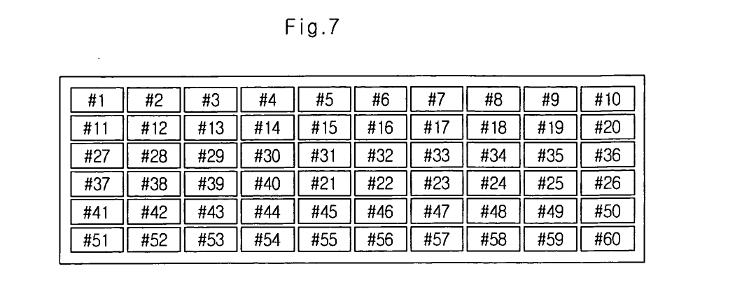

In other words, as shown in FIG. 6, if the user who intends to move a specific recording section (corresponding to 6 minutes after #21) to other section (before #41) moves only the location of the thumbnail image, the user can obtain an edited program as shown in FIG. 7.

Also, in case of editing different programs together, the editing of the recorded program is possible by showing all the thumbnail images of both pictures on a picture in the same manner and exchanging or moving the corresponding thumbnail images.

Thus, it is possible to implement the complicated editing function intuitively and easily by using the thumbnail image extracted in advance during editing of the recorded program.

This editing concept enables to perform most of program editing functions (storing/deleting/merging/dividing/inserting) within a section-editing unit (ex. unit of 60 seconds) and also to easily process even the complicated function such as alteration of the program reproduction sequence, etc.

In addition, it is possible to conveniently use the input key of the remote control by allocating and using a directional key and an input key performing functions of selecting, deleting and storing the thumbnail image.

The editing apparatus and method of a recorded program using a thumbnail image according to the present invention allows users to conveniently edit the recorded program by setting a predetermined editing section, extracting the thumbnail image representing the corresponding section and deleting, storing and moving the thumbnail image.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An editing apparatus using a thumbnail image, comprising:
an image processing means for processing a broadcasting stream and an image signal to permit the processed broadcasting stream and image signal to be displayed;
a display means for displaying an image;
an image extracting means for extracting the thumbnail image of the recorded broadcasting stream;
a storing means for storing the broadcasting stream and the thumbnail image; and
a control means for allowing a plurality of thumbnail images displayed on the display means according to a user's control command and thereby allowing the broadcasting stream represented by the thumbnail image to be edited.

2. The editing apparatus of claim 1, wherein the thumbnail image is extracted at a predetermined time interval.

3. The editing apparatus of claim 1, wherein the thumbnail image is extracted at each scene change point.

4. The editing apparatus of claim 1, wherein the thumbnail image is extracted by using histogram information on each frame of the broadcasting stream.

5. The editing apparatus of claim 1, wherein the editing of the broadcasting stream is performed by deleting, storing and moving the thumbnail image.

6. An editing method using a thumbnail image, comprising the steps of:
extracting and storing the thumbnail image of a broadcasting stream;
displaying a plurality of thumbnail images in response to a user's request;
editing the plurality of thumbnail images; and
editing a section of the broadcasting stream represented by the plurality of thumbnail images.

7. The editing method of claim 6, wherein the extracting step of the thumbnail image is performed while the broadcasting stream is stored.

8. The editing method of claim 6, wherein the thumbnail image is extracted at a predetermined interval while the broadcasting stream is stored.

9. The editing method of claim 6, wherein the thumbnail image is extracted by using histogram information on each frame of the broadcasting stream.

10. The editing method of claim 6, wherein the thumbnail image is extracted at each scene change point.

11. The editing method of claim 6, wherein the editing of the thumbnail image is performed by a method deleting, moving and separately storing a part of the plurality of thumbnail images.

12. The editing method of claim 6, wherein the editing of the broadcasting stream is performed concurrently with the editing of the thumbnail image.
